(19) United States
(12) Patent Application Publication
(10) Pub. No.: US 2025/0092322 A1
(43) Pub. Date: Mar. 20, 2025

(54) CONVERTING SUPER LIGHT CRUDES, EXTRA LIGHT CRUDES, AND CONDENSATES TO CHEMICALS

(71) Applicant: LUMMUS TECHNOLOGY LLC, Houston, TX (US)

(72) Inventors: Ujjal K. Mukherjee, Houston, TX (US); Kandasamy M. Sundaram, Houston, TX (US)

(73) Assignee: LUMMUS TECHNOLOGY LLC, Houston, TX (US)

(21) Appl. No.: 18/781,758

(22) Filed: Jul. 23, 2024

Related U.S. Application Data
(60) Provisional application No. 63/582,769, filed on Sep. 14, 2023.

(51) Int. Cl. C10G 69/06; B01D 3/14; B01J 6/00; C10L 1/04

(52) U.S. Cl. CPC C10G 69/06; B01D 3/14; B01J 6/008; C10L 1/04

(57) ABSTRACT

Processes and systems for converting a wide boiling hydrocarbon mixture to chemicals herein heating a hydrocarbon feedstock to form a heated hydrocarbon feedstock. The heated hydrocarbon feedstock is separated to recover a vaporized light portion and a remaining liquid portion. The vaporized light portion is superheated and thermally cracked to recover a first cracked effluent, and the remaining liquid portion is heated and stripped to recover a stripped vapor mixture and a residue liquid portion. The stripped vapor mixture is separated to recover a vapor comprising the stripping medium and a stream comprising volatilized hydrocarbons. The volatilized hydrocarbons are heated and mixed with hydrogen then hydroprocessed to form crackable heavy hydrocarbons. The hydroprocessed effluent is separated to recover a hydroprocessed liquid stream comprising crackable heavy hydrocarbons and a hydroprocessed vapor stream comprising unreacted hydrogen. The hydroprocessed liquid stream is superheated and thermally cracked to recover a second cracked effluent.

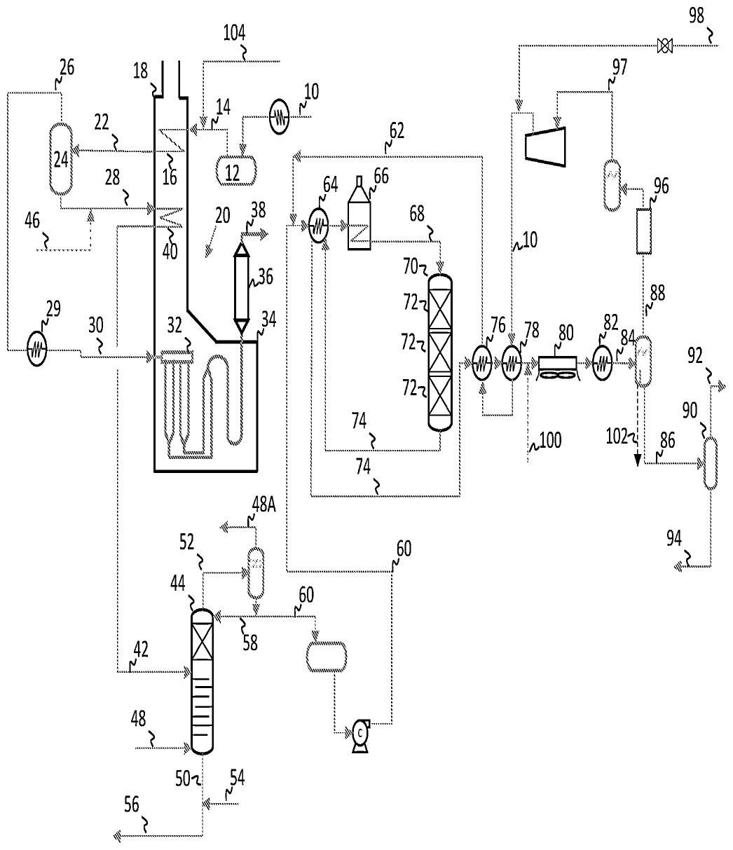

### FIELD OF THE DISCLOSURE

Embodiments of the present disclosure generally relate to converting super light crudes, extra light crudes, and condensates to chemicals.

### BACKGROUND

Traditionally, crude is separated into various cuts in crude and vacuum distillation sections in a refinery. Each fraction separated from crude is then routed to separate processing units, such as hydrotreaters, hydrocrackers and residue hydrocrackers, and the distillate products from these secondary units are then routed to a steam cracker or aromatics plant for conversion to chemicals.

Super light and extra light crudes and condensates have very low residue content and are low in sulfur and other contaminants such as metals. Processing the whole crude in the steam cracker directly without any separation of residue is not practiced because even the super light and extra light crudes and condensates contain small amounts of asphaltenes and heavy polynuclear aromatics which will foul heater tubes in the steam cracker and especially the transfer line exchangers (TLE).

Prior practice involves separating the lighter fraction from these super and extra light crudes in a separation device or tower into a light fraction that is sent to the steam cracker for production of olefins. The heavy fraction is rejected as low sulfur fuel oil. If the separation device or column, including crude or vacuum columns, lifts boiling below nominal residue true distillation cut point of 540° C., the thermal cracking of such a wide boiling range mixture will result in lower olefins yields and faster fouling of the pyrolysis heaters and transfer line exchangers. Separating the crude into two cuts will slightly increase olefins selectivity, but the heavier cut will cause accelerated heater and TLE fouling and result in the generation of larger amounts of pyrolysis oil.

Hydroprocessing the entire crude can be done, but it will deactivate the hydroprocessing catalyst quickly, resulting in excessive capital and operating costs.

Various patents and applications provide for using different hydroprocessing schemes to convert crude and other wide boiling mixtures to chemicals. While effective for converting crudes to chemicals, such processes may be overkill (and capital intensive) for efficiently processing of superlight crudes, extra light crudes, and condensates.

In view of the above challenges, currently crude distillation units with hydroprocessing of various cuts is still the standard practice for processing of even superlight crudes, extra light crudes, and condensates. The hydroprocessed cuts are then sent to olefins units or recovered as fuel.

### SUMMARY OF THE CLAIMED EMBODIMENTS

In one aspect, embodiments disclosed herein relate to a process for converting a wide boiling hydrocarbon mixture to chemicals. The process includes heating a hydrocarbon feedstock, the hydrocarbon feedstock comprising an ultralight crude, a extra light crude, a light crude, or a condensate liquid, to form a heated hydrocarbon feedstock. The heated hydrocarbon feedstock is separated to recover a vaporized light portion and a remaining liquid portion. The vaporized light portion is superheated and thermally cracked to recover a first cracked effluent, and the remaining liquid portion is heated and stripped to recover a stripped vapor mixture comprising a stripping medium and volatilized hydrocarbons and a residue liquid portion. The stripped vapor mixture is separated to recover a vapor comprising the stripping medium and a condensed hydrocarbon stream comprising condensed volatilized hydrocarbons. The condensed volatilized hydrocarbons are heated and mixed with hydrogen to form a reactant feed stream, which is fed to a hydroprocessing reactor to convert hydrocarbons therein, forming an effluent comprising crackable heavy hydrocarbons and effluent gases including unreacted hydrogen. The effluent is separated to recover a hydroprocessed liquid stream comprising the crackable heavy hydrocarbons and a hydroprocessed vapor stream comprising the unreacted hydrogen. The hydroprocessed liquid stream is superheated and thermally cracked to recover a second cracked effluent.

In another aspect, embodiments disclosed herein relate to a system for converting a wide boiling hydrocarbon mixture to chemicals. The system includes a heat exchanger for heating a hydrocarbon feedstock, the hydrocarbon feedstock comprising an ultralight crude, an extra light crude, a light crude, or a condensate liquid, to form a heated hydrocarbon feedstock. A separator is provided for separating the heated hydrocarbon feedstock to recover a vaporized light portion and a remaining liquid portion. A heating coil, such as a convective coil and a radiant coil of a cracking furnace, are provided for superheating and thermally cracking the vaporized light portion to recover a first cracked effluent. A heat exchanger is included in the system for heating the remaining liquid portion, and a stripper for stripping the remaining liquid portion to recover a stripped vapor mixture comprising a stripping medium and volatilized hydrocarbons and a residue liquid portion. The system further includes a separator for separating the stripped vapor mixture to recover a vapor comprising the stripping medium and a condensed hydrocarbon stream comprising condensed volatilized hydrocarbons, as well as a heat exchanger for heating the condensed volatilized hydrocarbons and mixing the condensed volatilized hydrocarbons with hydrogen to form a reactant feed stream. A flow line is provided for feeding the reactant feed stream to a hydroprocessing reactor, and the hydroprocessing reactor to convert hydrocarbons therein, forming an effluent comprising crackable heavy hydrocarbons and effluent gases including unreacted hydrogen. The system also includes a separator for separating the effluent to recover a hydroprocessed liquid stream comprising the crackable heavy hydrocarbons and a hydroprocessed vapor stream comprising the unreacted hydrogen. Further, the system includes a heating coil for superheating and thermally cracking the hydroprocessed liquid stream to recover a second cracked effluent.

Other aspects and advantages will be apparent from the following description and the appended claims.

### BRIEF DESCRIPTION OF DRAWINGS

The FIGURE illustrates a simplified process flow diagram of systems for producing chemicals according to one or more embodiments disclosed herein.

### DETAILED DESCRIPTION

Embodiments of the present disclosure generally relate to converting super light crudes, extra light crudes, and condensate liquids to chemicals. Embodiments herein may also be used to convert sweet light crudes to chemicals.

The properties of various types of crude oils and condensate liquids are outlined in Table 1. While these properties may vary widely, depending upon the reservoir from which the crude or condensate is produced, the values in Table 1 provide a rough guideline for defining feedstocks suitable for use in embodiments.

TABLE 1

| Feedstock | API Gravity | Sulfur content (wt. %) |
|---|---|---|
| Super Light Crude | >40° | <0.5 |
| Extra Light Crude | 36°-40° | 0.5-1.3 |
| Light Crude | 32°-36° | 1.3-2.2 |
| Medium Crude | 29°-32° | 2.2-2.9 |
| Heavy Crude | <29° | >2.9 |
| Condensate Liquids | >40°, such as 45°-80° | <2 |

The various grades of crude noted above may vary from sweet (low sulfur content) to sour (high sulfur content). Embodiments herein are useful for converting sweet crudes to chemicals but have the ability to effectively process sour crudes as well. The super light crudes, extra light crudes, and light crudes may contain, for example, 1 to 5 wt % residue (hydrocarbons having a boiling point greater than 540° C.). Various crudes may contain a greater amount of residue, such as up to or exceeding 20 wt %, and those typically classified as medium or heavy crudes are generally not suitable for processes herein. Embodiments herein are particularly well-suited to crudes with material boiling above 540° C., not exceeding 5%; higher amounts of 540° C.+ material can be handled but with an economic penalty, not a process penalty.

Similar to crudes, condensates may also vary widely. Condensate, as produced from a well, may be referred to as “poor” or “lean”, “middle”, or “rich”. “Poor” or “lean” condensate typically have a high amount of methane and ethane and a low amount of intermediate (C3-C11) or heavy hydrocarbons (C12+). For example, a poor or lean condensate may have from 1.5 to 15 wt % intermediate hydrocarbons and less than 2 wt % heavy hydrocarbons. A middle condensate may have, for example, 7 to 20 wt % intermediate hydrocarbons and from 2 wt % up to 4 or 5 wt % heavy hydrocarbons. A rich condensate may have, for example, 15 to 25 wt % intermediate hydrocarbons and from 4 or 5 wt % up to 9 or 10 wt % heavy hydrocarbons.

Following separation of the methane and ethane (natural gas), the remaining condensate liquids are generally much lighter than crudes. For example, condensate liquids may include from about 0.1 up to about 5 wt % C4-, 40 to 65 wt % naphtha range hydrocarbons, 20 to 40 wt % jet fuel or diesel fuel range hydrocarbons, 1 to 10 wt % vacuum gas oil range hydrocarbons, and up to 20 wt % residue, such as from 1 to 5 wt % residue. Similar to crudes, condensate liquids may be sweet or sour, and the content of residue, compounds boiling above 540° C., in the condensate liquids may vary significantly. Embodiments herein may process both sweet and sour condensate liquids, as well as condensate liquids recovered from poor, lean, middle, or rich condensates. Embodiments herein are well-suited for condensates with 5% or less of residual components boiling above 540° C.

Crude and condensate liquid feedstocks useful in various embodiments herein may have an API gravity of greater than 32°; greater than 35° in other embodiments; greater than 40° in other embodiments; and greater than 45° or greater than 50° in yet other embodiments.

In various embodiments, crude and condensate liquid feedstocks have a residue content, or a content of materials boiling above 540° C., of less than 10 wt %; less than 8 wt % in other embodiments; less than 5 wt % in other embodiments; less than 4 wt % in other embodiments; less than 3 wt % in other embodiments; and less than 2 wt % in yet other embodiments.

Crude and condensate liquid feedstocks processed according to embodiments herein may also have a low sulfur content, such as less than 2 wt %; less than 1 wt % in other embodiments; less than 0.5 wt % in other embodiments; and less than 0.2 wt % in yet other embodiments. In particular embodiments, crudes and condensate liquids used as feedstocks herein are “sweet,” containing less than 0.2 wt % sulfur. Crude and condensate liquid feedstocks processed according to embodiments herein may also have a low content of metals and Conradson Carbon Residue (CCR).

In some embodiments, for example, the hydrocarbon feedstock may have an API gravity greater than 32°, and a sulfur content of less than 0.5 wt %. In other embodiments, the hydrocarbon feedstock has: an API gravity greater than 45°, greater than 46°, greater than 47°, greater than 48°, or greater than 49°; a sulfur content of less than 0.5 wt %, less than 0.2 wt %, less than 0.1 wt %, or less than 0.07 wt %; less than 200 ppm nitrogen, less than 150 ppm nitrogen, less than 100 ppm nitrogen; a Conradson Carbon Residue (CCR) content of less than 1 wt %, less than 0.7 wt %, less than 0.5 wt %, or less than 0.4 wt %; and, a content of hydrocarbons boiling above 540° C. of less than 5%, less than 4%, less than 3%, or less than 2 wt %. As an example, an Arab Superlight crude, among others, may be a suitable feed meeting one or more of the above combination of properties.

The above-described feeds may be fed to a desalter, producing a desalted crude or condensate feedstock. The desalted feed is then heated, such as in a convection coil located in the convection section of a thermal cracking furnace. In some embodiments the desalted feed is split into multiple streams and fed to two or more heaters or convection coils to increase a temperature of the desalted feed. For example, the desalted feed may be heated to a temperature in a range from about 135° C. to about 210° C., such as 150° C.° to 180° C.

The heated feedstock is then fed to a separation system for separating a light paraffinic fraction or cut, recovered as a vapor from the separation system, from the heavier hydrocarbons in the desalted feed, recovered as a liquid from the separation system. The separation system may include, for example, an advanced separation device (ASD), such as described in U.S. Pat. No. 11,407,950. In some embodiments, the separation system is a simple flash drum, recovering the hydrocarbons volatilized in the heating coil. As another example, the separation system may include a Heavy Oil Processing Scheme (HOPS), such as described in U.S. Pat. No. 10,208,257. Due to the fouling tendency of heavier hydrocarbons, the ASD or HOPS are preferred over simple flash drums so as to limit entrainment of liquid droplets that may contain the heavier hydrocarbons. Since the initial boiling material is highly paraffinic, it is denoted as light paraffinic cut and it will contain paraffins, olefins, naphthenes and aromatics. The light paraffinic cut recovered as a vapor from the separation system may have an end boiling point, for example, in a range from 135° C. to 225° C., for example, such as from about 160° C. to about 180° C.

The light paraffinic cut may then be further heated and superheated using one or more heat exchangers. The heaters used for superheating the light paraffinic fraction may be located external to the cracking furnace, within the convection zone of the cracking furnace, or both. In some embodiments, the external heaters used may be electric heaters, or may use steam or other heat transfer fluids to increase a temperature of the light paraffinic cut.

The light paraffinic cut is then fed to a radiant coil of the cracking furnace to rapidly increase the temperature of the hydrocarbons therein to a cracking temperature, such as greater than 700° C. up to about 1100° C., thereby thermally cracking the hydrocarbons to produce lighter hydrocarbons, such as ethylene, propylene, and butenes, among others. The effluent(s) from the radiant coils are then fed to a transfer line exchanger to rapidly quench the cracked effluent to a temperature below cracking temperature. Additional heat may then be recovered from the cracked effluent and the cooled effluent is fed to a fractionation zone to separate the cracked effluent into various hydrocarbon fractions. Separation systems associated with a thermal cracking system may vary and may be used to separate the cracked effluent into broad cuts, such as a hydrogen fraction, a C1, C2-, C3- or C4-cut, a naphtha range cut, a diesel or jet fuel range cut, a gas oil range cut, and a pyrolysis oil (heavy/bottoms) fraction. Some separation systems used in embodiments of fractionation zones herein may include demethanizers, decthanizers, depropanizers, as well as separators to recover the various olefins, such as a deethylenizer to separate ethylene from ethane, a depropylenizer to separate propane from propylene, as well as debutanizers, deisobutylenizers, or other various separators and distillation columns or extractive distillation columns that are known in the art for recovering specific hydrocarbons or hydrocarbon cuts from a mixture of hydrocarbons.

Depending upon the aromaticity, sweetness, or fouling tendency of middle boiling components in the crude or condensate liquid feedstock, the end boiling point of the light fraction may range up to about 350° C. In some embodiments a first separator, such as an ASD or a HOPS, may be used to recover a light boiling fraction, such as having an end boiling point in a range from 160° C. to 180° C., as described above, and following heating of the remaining heavier hydrocarbons, a second separator, such as an ASD or a HOPS, may be used to recover an intermediate boiling range hydrocarbon cut, such as having an initial boiling point in a range from 160° C. to 180° C. and an end boiling point in a range from 280° C. to 350° C. The intermediate cut may be superheated and fed to a radiant coil to produce chemicals, such as ethylene and propylene, among others, and the cracked intermediate cut effluent may be quenched in a common or separate transfer line exchanger, fed to heat recovery, and thence to the fractionation zone for recovery of the various hydrocarbon fractions along with the other cracked effluents.

The heavier hydrocarbons recovered from the separation system still contain residue, and the residue portion is removed from the heavy hydrocarbons, after which the residue-free heavy hydrocarbons are hydroprocessed to increase the crackability of the feed, and the hydroprocessed heavies are fed to a radiant coil of the cracking furnace to produce chemicals. Hydroprocessing according to embodiments herein may include one or more of hydrodesulfurization, hydrodemetallization, hydrodenitrification, hydrogenation, and ring opening to remove sulfur, nitrogen and metals, reduce the CCR, or otherwise enhance the crackability of the heavier hydrocarbons. Though there is no specific limit for CCR, for economic reasons less than 2 wt % CCR is preferred. In some embodiments, hydroprocessing does not include hydrocracking of the heavies. The hydroprocessed heavies are then superheated and fed to a radiant coil to produce chemicals, such as ethylene and propylene, among others, and the cracked heavy cut effluent may be quenched in a common or separate transfer line exchanger, fed to heat recovery, and thence to the fractionation zone for recovery of the various hydrocarbon fractions along with the other cracked effluents.

To separate the residue and improve the crackability of the heavy hydrocarbons, the heavier hydrocarbons recovered from the separation system are heated, such as in a convective coil of the cracking furnace, then fed to a hot hydrogen or hot natural gas stripper. One or more additional heavy, difficult to crack feeds, such as gasoil or vacuum gas oil (VGO), may optionally be combined with the heavier hydrocarbons prior to heating or stripping.

In the stripper, the heavy hydrocarbons are contacted with hot hydrogen or hot natural gas (methane, ethane, or a mixture thereof) to separate heavy vaporizable hydrocarbons from the residue. The hydrogen or natural gas may be superheated, and at a temperature sufficient to vaporize and lift hydrocarbons having a normal boiling point up to 480° C., up to 500° C., up to 520° C., or up to 540° C. using the stripping medium. The remaining residue may be recovered as a bottoms fraction from the stripper, and a mixture of hydrogen and vaporized heavy hydrocarbons may be recovered as an overheads fraction from the stripper. It is noted that while the normal boiling points are noted, the actual conditions used in the stripper may vary, and may be less than the noted cut point where the stripper is operated under a partial vacuum. The residue recovered as a bottoms fraction may be recovered as a very low sulfur fuel oil or may be combined with a pyrolysis oil fraction from the fractionation zone used for separating the cracked effluents to produce a very low sulfur fuel oil.

The overheads fraction from the stripper are then condensed to separate the volatilized heavy hydrocarbons from the stripping medium, which may be compressed, re-heated and circulated for continued use in the stripper. A portion of the condensed heavy hydrocarbons may be used as a reflux fed to the stripper. The remaining condensed heavy hydrocarbons are heated, mixed with hydrogen (or mixed with hydrogen then heated) and fed to a hydroprocessing reactor. The hydroprocessing reactor may contain one or more beds of catalyst suitable to perform one or more of the following reactions: convert the sulfur and nitrogen in the hydrocarbons to hydrogen sulfide and ammonia; to hydrogenate aromatic compounds; and, to facilitate ring opening reactions to open rings of cyclic, aromatic, or naphthenic compounds. Optionally, the catalyst may include a cracking functionality, and the cracking may be minimal or maximal, and the need or desire for cracking functionality may depend upon the feedstock being processed.

The hydroprocessing reactor effluent is then cooled and separated from any unreacted hydrogen, as well as from the hydrogen sulfide, and the ammonia produced in the reactor. The cooling may be performed by one or more feed/effluent exchangers, such as heating of the condensed heavy hydrocarbons from the stripper, or for heating of the hydrogen feed to the hydroprocessing reactor. The hydroprocessed heavies, conditioned to be an improved cracking feed, are then recovered, mixed with dilution steam, and fed to a radiant coil of the cracking furnace to produce chemicals, as noted above.

In some embodiments, the hydroprocessed heavies are mixed with water to facilitate removal of polar compounds. The cooled hydroprocessed heavies in such embodiments may be separated to recover a sour water, a vapor fraction including hydrogen, hydrogen sulfide, and ammonia, as well as a hydroprocessed heavies product fed to the cracking furnace as described earlier.

The separated vapors may then be processed to recover the unreacted hydrogen. For example, one or more separation systems may be used to separate the unreacted hydrogen from hydrogen sulfide and ammonia, providing a recycle hydrogen stream that may be compressed, heated, and fed to the hydroprocessing reactor. Make-up hydrogen is provided to the system as required.

Dilution steam may be added to aid in the separation and heating of the desalted feed, as well as to limit or prevent fouling during heating of the desalted feed, the heated feedstock upstream of or during separation in the separation system or superheating of the light paraffinic cut. Thus, steam may be added in one or multiple locations, such as downstream of the desalter and upstream of the convective heating coil, downstream of the convective heating coil and upstream of the separation system (flash drum, ASD, or HOPS), directly to the separation system (flash drum, ASD, or HOPS), or downstream of the separation system (flash drum, ASD, or HOPS) and upstream of the superheating heaters or convective coils, for example. Similarly, steam may be added to the hydroprocessed fraction upstream of superheating coils prior to cracking of the hydroprocessed fraction within the radiant coils of the cracking furnace.

A simplified process flow diagram of the above-described system for converting condensate liquids and extra light, super light, or light crudes to chemicals is illustrated in the provided FIGURE.

A feedstock 10, such as a super light crude, ultralight crude, condensate liquid or sweet light crude, for example, may be fed to a desalter 12, producing a desalted crude or condensate feedstock 14. The desalted feed 14 is then heated in a convection coil 16 located in the convection section 18 of a thermal cracking furnace 20. The heated feedstock 22 is then fed to a separation system 24 for separating a light paraffinic fraction or cut, recovered as a vapor 26 from the separation system, from the heavier hydrocarbons in the desalted feed, recovered as a liquid 28 from the separation system.

The light paraffinic cut 26 may then be further heated and superheated using one or more heat exchangers 29. Overhead of separator stream 26 can also be heated (not shown in FIGURE) in the convection section of a heater instead of heating in an exchanger and then can enter the radiant section. The heater exchangers 29 used for superheating the light paraffinic fraction may be located external to the cracking furnace, within the convection zone of the cracking furnace, or both. In some embodiments, the external heaters used may be electric heaters, or may use steam or other heat transfer fluids to increase a temperature of the light paraffinic cut.

The superheated light paraffinic cut 30 is then fed to a radiant coil 32 located in the radiant section 34 of the cracking furnace 20 to rapidly increase the temperature of the hydrocarbons therein to a cracking temperature, thereby thermally cracking the hydrocarbons to produce lighter hydrocarbons, such as ethylene, propylene, and butenes, among others. The effluent(s) from the radiant coils are then fed to a transfer line exchanger 36 to rapidly quench the cracked effluent to a temperature below cracking temperature. Additional heat may then be recovered from the quenched cracked effluent 38 and the cooled effluent is fed to a fractionation zone (not illustrated) to separate the cracked effluent into various hydrocarbon fractions.

Liquid 28, the heavier hydrocarbons recovered from separation system 24 still contain residue. Liquid 28 is heated, such as in a convective coil 40 of cracking furnace 20, then the heated liquid 42 is fed to a hot hydrogen or hot natural gas stripper 44. One or more additional heavy, difficult to crack feeds 46 may optionally be combined with the heavier hydrocarbons 28 prior to heating or stripping. Heavy feed may be heated in the same furnace where light feeds are heated or heated in a separate furnace where it will be cracked in the radiant coils.

In the stripper 44, the heavy hydrocarbons are contacted with a stripping medium 48, such as hot hydrogen or hot natural gas (methane, ethane, or a mixture thereof) to separate heavy vaporizable hydrocarbons from the residue. The hydrogen or natural gas may be superheated, and at a temperature sufficient to vaporize and lift hydrocarbons having a normal boiling point up to 540° C., for example, using the stripping medium. The remaining residue may be recovered as a bottoms fraction 50 from the stripper, and a mixture of hydrogen and vaporized heavy hydrocarbons may be recovered as an overheads fraction 52 from the stripper. The residue recovered as a bottoms fraction 50 may be combined with a pyrolysis oil fraction 54, recovered from the fractionation zone (not illustrated) used for separating the cracked effluents, to produce a very low sulfur fuel oil 56.

The overheads fraction 52 from the stripper are then condensed to separate the volatilized heavy hydrocarbons from the stripping medium 48A, which may be compressed, re-heated and circulated for continued use in the stripper. A portion of the condensed heavy hydrocarbons may be used as a reflux 58 fed to stripper 44. The remaining condensed heavy hydrocarbons 60 are mixed with hydrogen 62 then heated in one or more heat exchangers 64 and/or heaters 66 to heat the hydrocarbons therein to appropriate hydroprocessing conditions. The heated heavies 68 are then fed to a hydroprocessing reactor 70. The hydroprocessing reactor 70 may be a fixed bed reactor containing one or more beds of catalyst 72 suitable to perform the desired hydroprocessing reactions. In other embodiments, hydroprocessing reactor 70 may include one or more ebullated bed, fluidized bed, or fixed bed reactors, arranged in series or parallel, to perform the desired hydroprocessing reactions.

The hydroprocessing reactor effluent 74 is then cooled in feed/effluent exchangers 64, 76, 78 and one or more additional exchangers 80, 82. The cooled hydroprocessed effluent 84 is then separated to recover a hydroprocessed heavies stream 86 and effluent gases 88, including any unreacted hydrogen, as well as from the hydrogen sulfide, and the ammonia produced in the reactor. The hydroprocessed heavies 86, conditioned to be an improved cracking feed, are then recovered, mixed with dilution steam, and fed to a radiant coil (not shown) of the cracking furnace to produce chemicals, as noted above. If desired or necessary, the hydroprocessed heavies may be fed to a stabilizer 90 to remove any dissolved or entrained gases 92, and the stabilized hydroprocessed heavies 94 may be fed to the radiant coil (not shown) of the cracking furnace. The gases 92 are fed to a recovery unit (not illustrated), such as a pressure swing adsorption (PSA) unit for recovery of hydrogen. Effluent gases 88 may be fed to one or more adsorbers or separation units 96 to separate unreacted hydrogen 97 from ammonia and hydrogen sulfide, and the recovered hydrogen 97 may be compressed and fed along with any make-up hydrogen 98 to the hydrogen heaters 76, 78 and thence to the hydroprocessing reactor 70.

In some embodiments, the hydroprocessed heavies are mixed with water 100 to facilitate removal of polar compounds. The cooled hydroprocessed heavies in such embodiments may be separated to additionally recover a sour water 102.

Dilution steam 104 may be added to aid in the separation and heating of the desalted feed, as well as to limit or prevent fouling during heating of the desalted feed. While illustrated in the FIGURE as steam 104 being combined with the desalted feed, the dilution steam 104 may be added in one or multiple locations, such as downstream of the desalter and upstream of the convective heating coil, downstream of the convective heating coil and upstream of the separation system (flash drum, ASD, or HOPS), directly to the separation system (flash drum, ASD, or HOPS), or downstream of the separation system (flash drum, ASD, or HOPS) and upstream of the superheating heaters or convective coils, for example. Similarly, steam may be added to the hydroprocessed fraction 86, 94 upstream of superheating coils prior to cracking of the hydroprocessed fraction within the radiant coils of the cracking furnace.

As described above, embodiments herein may be used to process superlight, extra light, and light crudes and condensates. Sweet, super light, extra light and light crudes and condensates may contain very low levels of sulfur, nitrogen and metals. Therefore, these crudes can be converted to chemicals economically without a crude distillation column. These crudes may also have low residue content (fraction boiling above about 540° C.) and because of the low sulfur nature of the crude or condensate, the residual fraction is suitable for making fuel oil meeting IMO sulfur standards. Lighter portions of the crude or condensate feed are separated into two cuts using a separator, such as an advanced separation device (ASD) or a heavy oil processing scheme (HOPS). The lighter cut will be directly sent for thermal cracking in a traditional olefins heater and the heavier fraction will be sent to a hydroprocessing reactor after removing the residue using hot hydrogen stripping. After hydroprocessing, the entire cut will be thermally cracked in olefin producing reactors.

Although the super light and extra light crudes and condensates may have a very low amount of residue, thermally cracking any residue fraction for olefin production is not recommended, as the residue does not produce any significant amount of olefins. Moreover, the residue cokes up the cracking reactor very quickly. Therefore, for thermal cracking of crudes to olefins, the residue portion has to be removed from the feed to the cracker. As the residue boiling point is high, to remove it by fractionation, the crude must be heated to high temperatures. This consumes energy. In embodiments herein, an advanced separation device or a HOPS is used to obtain a light fraction. Super light and extra light crudes and condensates have very high quantity of naphtha and lighter components. This cut is rich in paraffins and produces high olefin yields. In some embodiments, a 180° C.—cut is removed in the first stage of the separator (ASD or HOPS). This can be removed using an external heat source, such as medium pressure (MP) or high pressure (HP) steam or mixing with superheated dilution steam and vaporizing the fluid. By mixing with dilution steam, hydrocarbon partial pressure is reduced significantly, and thus boiling point is reduced. That is the advantage of direct injection of dilution steam. Thermal cracking of this cut requires dilution steam addition anyway. Therefore, the light portion of the crude is removed without going through crude distillation column in an energy efficient way. The heavy portion still contains residue that has to be removed. For this, embodiments herein employ a hot hydrogen stripper. As shown in the FIGURE, the bottoms of the advanced separation device are fed to a hot hydrogen stripper. Here, instead of steam, hot hydrogen is used to separate heavy vaporizable hydrocarbons from the residue. Hydrogen is used as one of the reactants in hydroprocessing. By superheating the hydrogen, enough energy is supplied to the heavy crude to lift 500° C. and lighter boiling material. The vapor mainly contains 180° C.-500° C. cut hydrocarbons from the crude and hydrogen used as the stripping medium. This mixture and any additional hydrogen required for hydroprocessing will enter the hydroprocessing reactors. Here the sulfur and nitrogen will be converted to hydrogen sulfide and ammonia and the aromatics will be hydrogenated to naphthenes. The catalyst system will open the naphthenic rings to increase the olefins potential in the steam cracker downstream of the hydroprocessing section. Depending upon the catalyst used, minimum or maximum hydrocracking reactions will occur. The products of the hydroprocessing unit will be separated to recover a hydrogen rich vapor and remaining hydrocarbon rich mixture. Hydrocarbon portion is sent to thermal cracking to olefin production. This cut has higher hydrogen content than the original hydrocarbons present in the crude. Therefore, on thermal cracking of this portion, olefin production will be higher than that of the straight run heavier hydrocarbons in the crude or condensate without hydroprocessing. The vapors from the hydroprocessing is sent to a pressure swing absorption (PSA) unit to recover unreacted hydrogen and additional hydrogen will be added before heating and sending it to the hot hydrogen stripper. The bottom of the hot hydrogen stripper (liquid) contains mainly residue and is sold as very low sulfur fuel oil. In this manner, the complete crude or condensate is processed. The light cut is thermally cracked as straight run feed and the heavy cut is hydroprocessed and thermally cracked. Residue is sold as fuel. All are achieved without using a crude distillation column. Superheated steam and hydrogen are used as heat sources, and they also form reactants to thermal cracking and hydroprocessing respectively. This reduces the overall energy consumption. Embodiments herein thus reduce the CAPEX and energy consumption to produce olefins from these feedstocks. As a portion of the heavy cut of the crude is upgraded by hydrogenation, olefin production is also increased. Only a small amount of hydrogen is required compared with hydroprocessing the full crude. This reduces pyrolysis oil produced in cracking reactors. The pyrolysis oil produced in the thermal cracking can also be hydrocracked and recycled to heaters or blended with the residue to make very low sulfur fuel oil. All products from the hydroprocessing section are normally fed to the steam cracker, but optionally a diesel meeting Euro VI specifications can be produced. The hydroprocessing section can also produce heavy naphtha suitable for catalytic reforming for aromatics production. Naphtha cut point (180° C.) or residue initial boiling point (525° C.) are typical, but these cut points can be varied depending upon the requirements and the feedstock being processed.

While described above with respect to a single cracking furnace, embodiments herein may utilize two or more cracking furnaces for processing of the various cracker feeds, including the paraffinic light cut and the hydroprocessed liquids and for providing heat to the various streams and generating utility steam, such as dilution steam, medium pressure steam, and high-pressure steam.

As outlined above, embodiments herein effectively and efficiently convert extra light crudes, super light crudes, and condensates to chemicals in an efficient and cost-effective manner. A person skilled in the field would generally propose a whole crude cracking scheme based on the high paraffin and high hydrogen content and lack of contaminants such as sulfur, nitrogen and metals in the extra light crudes and condensates. However, only after a very detailed analysis of the various fractions present in the heavy and very heavy fractions in terms of the type of molecules and the resultant impact on olefin yield and heater and transfer line exchanger (TLE) fouling rates, the present inventors arrived at the present schemes to maximize olefin yields, minimize fouling, and minimize capital.

Embodiments herein do not require crude and vacuum distillation columns and associated equipment. No residue hydroprocessing or residue hydrocracking is proposed for the heaviest fraction of the feedstocks. No deasphalting is needed to separate out asphaltenes, and hydrocracking is minimized or not included. In this manner, embodiments herein reduce capital expenses and reduce energy consumption. Only the hydrogen deficient portion of crude is hydroprocessed to maximize olefin yield and increase heater run length and reduce fouling of transfer line exchangers. Embodiments herein are thus a low capital and very efficient way to convert extra light crudes and condensates to chemicals with no low value products from the crude conversion. The crude to chemicals conversion according to embodiments herein is cheaper and more energy efficient than competing technologies and may be specifically tailored to sweet extra light ang light crudes.

Unless defined otherwise, all technical and scientific terms used have the same meaning as commonly understood by one of ordinary skill in the art to which these systems, apparatuses, methods, processes, and compositions belong.

As described herein, various streams are mixed or combined upstream or downstream of a processing unit. Mixing may occur in a mixing device, such as a vessel, an agitated vessel, a pump, or in a flow line, such as a tee or wye connection blending two streams, with or without a static mixer or other devices to enhance commingling of the two streams. Other types of mixing devices known in the art may also be used.

The singular forms “a,” “an,” and “the” include plural referents, unless the context clearly dictates otherwise.

As used here and in the appended claims, the words “comprise,” “has,” and “include” and all grammatical variations thereof are each intended to have an open, non-limiting meaning that does not exclude additional elements or steps.

“Optionally” means that the subsequently described event or circumstances may or may not occur. The description includes instances where the event or circumstance occurs and instances where it does not occur.

When the words “approximately” or “about” are used, this term may mean that there can be a variance in value of up to +10%, of up to 5%, of up to 2%, of up to 1%, of up to 0.5%, of up to 0.1%, or up to 0.01%.

Ranges may be expressed as from about one value to about another value, inclusive. When such a range is expressed, it is to be understood that another embodiment is from the one particular value to the other particular value, along with all particular values and combinations thereof within the range.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed as new and desired to be protected by Letters Patent is:

1. A process for converting a wide boiling hydrocarbon mixture to chemicals, the process comprising:
heating a hydrocarbon feedstock, the hydrocarbon feedstock comprising an ultralight crude, a extra light crude, a light crude, or a condensate liquid, to form a heated hydrocarbon feedstock;
separating the heated hydrocarbon feedstock to recover a vaporized light portion and a remaining liquid portion;
superheating and thermally cracking the vaporized light portion to recover a first cracked effluent;
heating the remaining liquid portion;
stripping the remaining liquid portion to recover a stripped vapor mixture comprising a stripping medium and volatilized hydrocarbons and a residue liquid portion;
separating the stripped vapor mixture to recover a vapor comprising the stripping medium and a condensed hydrocarbon stream comprising condensed volatilized hydrocarbons;
heating the condensed volatilized hydrocarbons and mixing the condensed volatilized hydrocarbons with hydrogen to form a reactant feed stream;
feeding the reactant feed stream to a hydroprocessing reactor to convert hydrocarbons therein, forming an effluent comprising crackable heavy hydrocarbons and effluent gases including unreacted hydrogen;
separating the effluent to recover a hydroprocessed liquid stream comprising the crackable heavy hydrocarbons and a hydroprocessed vapor stream comprising the unreacted hydrogen;
superheating and thermally cracking the hydroprocessed liquid stream to recover a second cracked effluent.

2. The process of claim 1, further comprising separating the first and second cracked effluents to recover one or more hydrocarbon fractions.

3. The process of claim 2, wherein the one or more hydrocarbon fractions includes a pyrolysis oil fraction, the process further comprising mixing the pyrolysis oil fraction with the residue liquid portion to form a very low sulfur fuel oil.

4. The process of claim 1, further comprising mixing dilution steam with one or more of the hydrocarbon feedstock, the heated hydrocarbon feedstock; the vaporized light portion; and the hydroprocessed liquid stream.

5. The process of claim 1, wherein the stripping medium comprises hydrogen.

6. The process of claim 1, wherein the stripping medium comprises methane, ethane, or natural gas.

7. The process of claim 1, wherein the hydroprocessing comprises one or more of hydrodesulfurization, hydrodenitrification, hydrodemetallization, hydrogenation, and ring opening.

8. The process of claim 7, wherein the hydroprocessing does not comprise hydrocracking.

9. The process of claim 1, wherein the vaporized light portion has an end boiling point in a range from 150° C. to 200° C.

10. The process of claim 9, wherein the volatilized hydrocarbons have an end boiling point in a range from 480° C. to 540° C.

11. The process of claim 10, wherein the separating the heated hydrocarbon feedstock to recover a vaporized light portion and a remaining liquid portion further comprises recovering a middle boiling fraction having an end boiling point in a range from 150° C. to 350° C.

12. The process of claim 1, wherein the hydrocarbon feedstock has an API gravity greater than 32°, and a sulfur content of less than 0.5 wt %.

13. The process of claim 1, wherein the hydrocarbon feedstock has an API gravity greater than 45°, a sulfur content of less than 0.1 wt %, less than 150 ppm nitrogen, a Conradson Carbon Residue (CCR) content of less than 0.5 wt %, and a content of hydrocarbons boiling above 540° C. of less than 5%.

14. A system for converting a wide boiling hydrocarbon mixture to chemicals, the system comprising:
a heat exchanger for heating a hydrocarbon feedstock, the hydrocarbon feedstock comprising an ultralight crude, an extra light crude, a light crude, or a condensate liquid, to form a heated hydrocarbon feedstock;
a separator for separating the heated hydrocarbon feedstock to recover a vaporized light portion and a remaining liquid portion;
a heating coil for superheating and thermally cracking the vaporized light portion to recover a first cracked effluent;
a heat exchanger for heating the remaining liquid portion;
a stripper for stripping the remaining liquid portion to recover a stripped vapor mixture comprising a stripping medium and volatilized hydrocarbons and a residue liquid portion;
a separator for separating the stripped vapor mixture to recover a vapor comprising the stripping medium and a condensed hydrocarbon stream comprising condensed volatilized hydrocarbons;
a heat exchanger for heating the condensed volatilized hydrocarbons and mixing the condensed volatilized hydrocarbons with hydrogen to form a reactant feed stream;
a flow line for feeding the reactant feed stream to a hydroprocessing reactor, and the hydroprocessing reactor to convert hydrocarbons therein, forming an effluent comprising crackable heavy hydrocarbons and effluent gases including unreacted hydrogen;
a separator for separating the effluent to recover a hydroprocessed liquid stream comprising the crackable heavy hydrocarbons and a hydroprocessed vapor stream comprising the unreacted hydrogen;
a heating coil for superheating and thermally cracking the hydroprocessed liquid stream to recover a second cracked effluent.

15. The system of claim 14, further comprising a separation system for separating the first and second cracked effluents to recover one or more hydrocarbon fractions.

16. The system of claim 15, wherein the one or more hydrocarbon fractions includes a pyrolysis oil fraction, the system further comprising a mixing device for mixing the pyrolysis oil fraction with the residue liquid portion to form a very low sulfur fuel oil.

17. The system of claim 14, further comprising a flow line or flow lines for mixing dilution steam with one or more of the hydrocarbon feedstock, the heated hydrocarbon feedstock; the vaporized light portion; and the hydroprocessed liquid stream.

18. The system of claim 14, further comprising a flow line for feeding hydrogen to the stripper as the stripping medium.

19. The system of claim 1, further comprising a flow line for feeding to the stripper a stripping medium comprising methane, ethane, or natural gas.
